(19) United States
(12) Patent Application Publication
(10) Pub. No.: US 2020/0412554 A1
(43) Pub. Date: Dec. 31, 2020

(54) ID AS SERVICE BASED ON BLOCKCHAIN

(71) Applicant: SANGMYUNG UNIVERSITY CHEONAN COUNCIL FOR INDUSTRY-ACADEMIC COOPERATION FOUNDATION, Cheonan-si, Chungcheongnam-do (KR)

(72) Inventor: Jong Hyouk Lee, Cheonan-si (KR)

(73) Assignee: SANGMYUNG UNIVERSITY CHEONAN COUNCIL FOR INDUSTRY-ACADEMIC COOPERATION FOUNDATION, Cheonan-si, Chungcheongnam-do (KR)

(21) Appl. No.: 16/957,731

(22) PCT Filed: Nov. 30, 2018
(86) PCT No.: PCT/KR2018/015046

§ 371 Date: Jun. 25, 2020

(30) Foreign Application Priority Data
Dec. 26, 2017 (KR) 10-2017-0179668

(51) Int. Cl. H04L 9/32; H04L 9/06; H04L 9/30; G06F 16/9035

(52) U.S. Cl. CPC H04L 9/3273; H04L 9/0643; H04L 2209/38; G06F 16/9035; H04L 9/30

(57) ABSTRACT

A blockchain based integrated identity and authentication management service method is a method of allowing a user who is subscribed to a provider to use a partner service through a virtual ID registered in a private blockchain managed and operated by the provider without subscribing to the partner service, in order to use the partner service associated with the provider. The user creates the virtual ID and registers the virtual ID in the private blockchain through the provider, and the user sends the virtual ID to a partner and requests a service. The partner verifies the virtual ID through the private blockchain, acquires a public key of the user from the private blockchain, and provides the service to the user via mutual authentication with the user, wherein additional personal information required is obtained through a separate personal information database held by the provider, not by the private blockchain.

### TECHNICAL FIELD

The present invention relates to an identity (ID) and authentication management infrastructure, and more particularly, to a system and method for receiving a service, to which a user does not subscribe, through mutual authentication using a virtual ID stored in a blockchain on the basis of the blockchain without generating a new ID.

### BACKGROUND ART

Blockchain technology is known as the underlying technology of virtual currency which is also known as cryptocurrency. Although the blockchain technology was first introduced as a technology for implementing virtual currency, it is being adopted for various services in various fields other than the financial field.

A blockchain has a decentralized ledger structure which is particularly well-suited for processing time-sequential data, and every participant in a blockchain network owns a ledger in which all transaction records are required. Therefore, transactions are highly transparent.

In particular, the use of an embedded encryption function of the blockchain technology can ensure the integrity of a ledger, the reliability of a transaction, etc. without a centralized system.

Lately, the computing industry is undergoing tremendous changes due to cloud computing. Software, platforms, and infrastructure can be provided to users in the form of cloud services. Identity (ID) management can also be provided to users in the cloud. In other words, a user can use an ID and authentication management infrastructure provided in the cloud in the form of ID as a service (IDaaS). However, when IDaaS is used, a third party manages and controls all data related to an ID and authentication (e.g., user account information and a security credential) without knowing how the data is protected and processed in the cloud, which is problematic.

### DISCLOSURE

### Technical Problem

The present invention is directed to enabling a user to use a new service using a virtual identity (ID) stored in a blockchain without creating a new ID and providing personal information for the new service.

The present invention is also directed to making it possible to use a new service without providing an ID and authentication-related data to a third party other than a blockchain-based ID as a service (BIDaaS) provider.

The present invention is also directed to making it unnecessary for a provider who provides a service to users to build and maintain an ID and authentication management infrastructure for users and removing a partner's load of having to safely store and manage user information.

The present invention is also directed to making it unnecessary for a user to create an account and manage all account information.

### Technical Solution

One aspect of the present invention provides an integrated identity (ID) and authentication management system based on a blockchain, the system including: a provider server, a partner server, and a user terminal.

The provider server has a private blockchain-based ID as a service (BIDaaS) blockchain for storing virtual IDs and public keys of users, has a right to write in the blockchain, and thus registers a virtual ID by generating a transaction including the virtual ID and adding the transaction to the blockchain according to a virtual ID registration request of a user.

According to a service request of the user, the partner server verifies the virtual ID through the private BIDaaS, acquires the public key of the user from the blockchain, and provides a service to the user through mutual authentication with the user terminal.

The user terminal requests the provider server to register the virtual ID, requests the partner server to provide the service, and performs the mutual authentication with the partner server.

In the integrated ID and authentication management system based on a blockchain, the provider server may include a database (DB) configured to store extra personal information of users and may provide the extra personal information of users according to a request of the partner server.

Another aspect of the present invention provides an integrated ID and authentication management service method based on a blockchain, the method including registering, by a provider server, a virtual ID in a blockchain according to a virtual ID registration request of a user terminal which generates the virtual ID, verifying, by a partner server, the virtual ID through the blockchain when a user requests a service from the partner server with which the user has not been registered in advance, acquiring a public key of the user to perform mutual authentication with the user terminal, and providing the service after the mutual authentication.

The integrated ID and authentication management service method based on a blockchain may further include, when a partner server requests extra personal information of a user, requesting and acquiring extra personal information from a provider server through a secured connection.

### Advantageous Effects

According to the proposed invention, a user can use a new service using a virtual identity (ID) stored in a blockchain without generating a new ID and providing personal information for the new service.

Also, according to the proposed invention, it is possible to use a new service without providing an ID and authentication-related data to a third party other than a blockchain-based ID as a service (BIDaaS) provider.

Further, the proposed invention makes it unnecessary for a provider who provides a service to users to build and maintain an ID and authentication management infrastructure for users and removes a partner's load of having to safely store and manage user information.

Moreover, the proposed invention makes it unnecessary for a user to create an account and manage all account information.

### DESCRIPTION OF DRAWINGS

FIG. 1 is a conceptual diagram of an integrated identity (ID) and authentication management system based on a blockchain according to an embodiment of the present invention.

FIG. 2 is a block diagram of a provider server according to an embodiment of the present invention.

FIG. 3 is a block diagram of a partner server according to an embodiment of the present invention.

FIG. 4 is a sequence diagram illustrating a process of registering a virtual ID of a user according to an embodiment of the present invention.

FIG. 5 is a sequence diagram illustrating a mutual authentication procedure between a user terminal and a partner server according to an embodiment of the present invention.

FIG. 6 is a sequence diagram illustrating an extra personal information acquisition process of a partner server according to another embodiment of the present invention.

### MODES OF THE INVENTION

The foregoing and additional aspects are implemented through embodiments described with reference to the accompanying drawings. It will be understood that components of each embodiment can be variously combined within the single embodiment as long as there is no other mention or mutual contradiction. Each block of a block diagram may represent a physical part in some cases, but in other cases, it may be a portion of a function of a single physical part or a logical representation of a function over a plurality of physical parts. In some cases, a block or an entity of a part thereof may be a set of program commands. These blocks may be entirely or partially implemented with hardware, software, or a combination thereof.

An integrated identity (ID) and authentication management system based on a blockchain according to an aspect includes a provider server 100, a partner server 200, and a user terminal 300.

The ID and authentication management system based on a blockchain registers a virtual ID generated by a user, who subscribes to the provider server 100 and provides personal information, in a blockchain-based ID as a service (BIDaaS) blockchain through the provider server 100 and enables the user to access the partner server 200 to which the user does not subscribe using the registered virtual ID and use a service provided by a partner.

When the system is used, the user does not need to join every partner company which provides a service that he or she wants to use by providing personal information, and also it is unnecessary to generate a separate ID for each individual service.

The provider server 100 is a server managed by a company which provides an integrated ID and authentication service based on a blockchain. For example, the provider may be a mobile communication company.

The provider server 100 includes a microprocessor and a memory which stores a program code block executed by the microprocessor, and the program code block performs a process of registering the virtual ID of the user by generating a transaction including the virtual ID of the user, a public key of the user, and an electronic signature of the virtual key and the public key made with his or her private key and adding the transaction to a private BIDaaS blockchain.

The provider server 100 has a BIDaaS blockchain which is copied from and synchronized with a private blockchain managed by the provider. The provider server 100 has both of rights to read from and write in the private BIDaaS blockchain and thus may add a block to the blockchain.

The virtual ID of the user and the public key of the user are received from the user terminal 300 which requests registration of the virtual ID. The provider server 100 generates the electronic signature of the virtual key and the public key made with his or her private key and registers the generated electronic signature in the private BIDaaS blockchain together with the virtual ID of the user and the public key of the user. Here, the registration is generated as a blockchain transaction, broadcast to private BIDaaS blockchain nodes, and stored in the blockchain via an agreement algorithm.

The agreement algorithm used for addition to the blockchain may be a practical byzantine fault tolerance (PBFT) algorithm or a proof of stake (PoS) algorithm. However, the present invention is not limited thereto.

Since the blockchain is a private blockchain, nodes which execute the agreement algorithm are nodes present in a management domain of the provider.

The partner server 200 is managed by a company which provides a service to users using an integrated ID and authentication service based on a blockchain, that is, a BIDaaS service, provided by the provider. For example, the partner may be an online shopping mall.

The partner server 200 includes a microprocessor and a memory which stores a program code block executed by the microprocessor, and the program code block performs a process of receiving a service request including the virtual ID of the user, verifying the virtual ID received from the user terminal 300 which requests the service through the private BISaaS blockchain, acquiring the public key of the user corresponding to the virtual ID from the BIDaaS blockchain, performing mutual authentication with the user terminal 300, and providing the service to the user who is mutually authenticated.

The partner server 200 has the BISaaS blockchain which is copied from and synchronized with the private blockchain managed by the provider. However, the partner server 200 has no right to write in the private BIDaaS blockchain but has the right to read from the private BIDaaS blockchain and thus may access the private BIDaaS blockchain using the right to read.

The user terminal 300 indicates a terminal used by the user who subscribes to the provider and means a personal computing device. In other words, a mobile phone, a personal computer (PC), a laptop PC, a tablet PC, etc. may be the user terminal 300. However, the user terminal 300 is not limited thereto. The user subscribes to the provider and provides personal information but has not been registered with the service of the partner. When using the service provided by the partner, the user neither generates a new ID for using the service of the partner nor provides personal information to the partner. For example, the user may be a mobile telephone service subscriber.

The user terminal 300 includes a microprocessor and a memory which stores a program code block executed by the microprocessor, and the program code block performs a process of registering the virtual ID by transmitting the virtual ID and the public key to the provider server 100, requesting the service by transferring the virtual ID to the partner server 200, and using the service provided by the partner after mutual authentication with the partner server 200.

The user terminal 300 does not have the BIDaaS blockchain which is copied from and synchronized with the private blockchain managed by the provider. Also, the user terminal 300 cannot access the private BIDaaS blockchain.

According to another aspect of the present invention, a secured connection may be established between the provider server 100 and the user terminal 300. For the secured connection, Internet protocol security (IPSec) or transport layer security (TLS) may be used. However, a security protocol for the secured connection is not limited thereto.

The provider server 100 may receive the virtual ID of the user and the public ID of the user from the user terminal 300 through the secured connection.

The user terminal 300 generates a pair of the private key and the public key and safely stores the private key. The virtual ID is generated using the public key. In other words, the user terminal 300 may generate the virtual ID by cryptographically hashing the public key. A cryptographic hash algorithm may be MD5 or SHA 256. However, a cryptographic hash algorithm is not limited thereto.

According to another aspect, an integrated ID and authentication management system based on a blockchain includes a provider server 100, a partner server 200, and a user terminal 300.

The provider server 100 may include a personal information DB 140 which stores extra personal information including real names, phone numbers, and addresses of registered users.

Only a provider has the extra personal information, and a partner may request the extra information from the provider server 100 when the extra information is required to execute a service. For example, when the provider is a mobile communication company and the partner is an online shopping mall, the partner may request address information of a user from the provider to deliver an item purchased by the user.

The extra personal information is stored in the personal information DB 140, which is a separate DB of the provider server 100, rather than a private BIDaaS blockchain.

According to another aspect of the present invention, a secured connection may be established between the provider server 100 and the partner server 200. For the secured connection, IPSec or TLS may be used. However, a security protocol for the secured connection is not limited thereto.

The partner server 200 may acquire extra personal information corresponding to a virtual ID of a user from the provider server 100 through the secured connection.

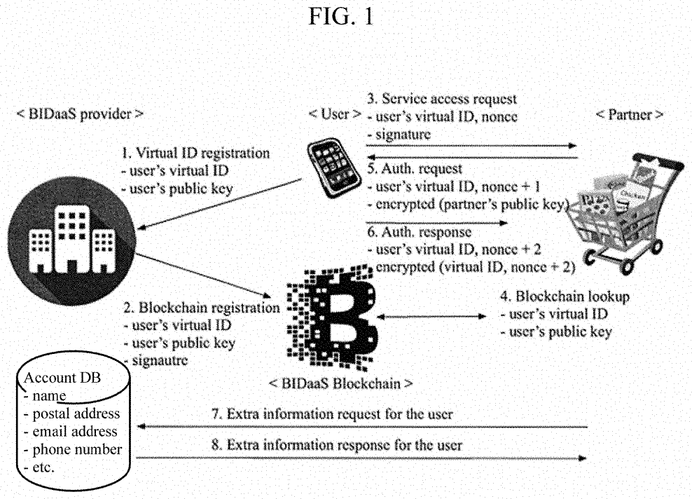

FIG. 1 is a conceptual diagram of an integrated ID and authentication management system based on a blockchain according to an embodiment of the present invention. In the example shown in FIG. 1, a BIDaaS provider is a provider corresponding to a mobile communication company, a user is a mobile user who subscribes to the BIDaaS provider, and a partner is an online shopping mall. FIG. 1 shows that BIDaaS is used as an ID and authentication management infrastructure for a mobile user of a mobile communication company.

In the embodiment of FIG. 1, the mobile user attempts to use the service of the online shopping mall which is in partnership with the mobile communication company.

Since personal information of the mobile user has already been registered in the mobile communication company, the mobile user may generates a virtual ID and register the virtual ID in a BIDaaS blockchain together with a corresponding public key (1. Virtual ID registration). The mobile user may register the virtual ID before using the service of the online shopping mall.

The mobile communication company registers the virtual ID of the user and the public key of the user in a private BIDaaS blockchain thereof together with a digital signature for the virtual ID and the public key (2. Blockchain registration).

Subsequently, the mobile user sends a service request message to the online shopping mall (3. Service access request). In this case, the message does not include actual ID information of the mobile user and includes the virtual ID of the mobile user.

The online shopping mall refers to the private BIDaaS blockchain with the virtual ID provided by the mobile user. The online shopping mall is in partnership with the mobile communication company, which is a BIDaaS provider, and thus may access the BIDaaS blockchain to acquire necessary data with the virtual ID. The online shopping mall acquires the public key of the user from the private BIDaaS blockchain (4. Blockchain lookup).

Subsequently, the online shopping mall performs mutual authentication with the mobile user using the public key of the user (5. Auth. request and 6. Auth. response).

After authentication and approval of the user's service request, the online shopping mall may require extra personal information of the user, such as the user's real name, phone number, and address. The extra personal information may be acquired from an account DB which is a personal information DB of the mobile communication company (7. Extra information request for the user and 8. Extra information response for the user).

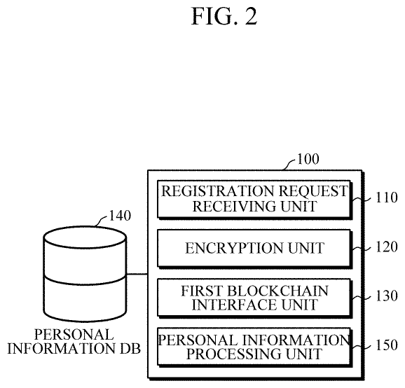

FIG. 2 is a block diagram of a provider server according to an embodiment of the present invention.

The provider server 100 of the integrated ID and authentication management system based on a blockchain according to the aspect includes a registration request receiving unit 110, an encryption unit 120, and a first blockchain interface unit 130.

The provider server 100 is a server managed by a company which provides an integrated ID and authentication service based on a blockchain. For example, the provider may be a mobile communication company.

The provider server 100 includes a microprocessor and a memory which stores a program code block executed by the microprocessor.

Also, the provider server 100 has a BIDaaS blockchain, which is copied from and synchronized with a private blockchain managed by the provider, and has both of rights to read from and write in the owned private BIDaaS blockchain.

The registration request receiving unit 110 may be implemented as a program code block executed by the microprocessor, that is, software. The registration request receiving unit 110 receives a virtual ID registration request including a virtual ID of a user and a public ID of a user from a user terminal 300.

The virtual ID is generated using the public key of the user. In other words, the public key is cryptographically hashed by the user terminal 300 so that the virtual ID may be generated. A cryptographic hash algorithm may be MD5 or SHA 256. However, a cryptographic hash algorithm is not limited thereto.

According to an aspect of the present invention, a secured connection may be established between the provider server 100 and the user terminal 300. For the secured connection, IPSec or TLS may be used. However, a security protocol for the secured connection is not limited thereto.

The registration request receiving unit 110 may receive the virtual ID of the user and the public key of the user from the user terminal 300 through the secured connection.

The encryption unit 120 may be implemented as a program code block executed by the microprocessor, that is, software. The encryption unit 120 generates an electronic signature by signing the virtual ID of the user and the public ID of the user with a private key thereof. The generated electronic signature may be verified with the public key of the provider server 100.

The first blockchain interface unit 130 may be implemented as a program code block executed by the microprocessor, that is, software. The first blockchain interface unit 130 accesses the BIDaaS blockchain under the control of an access control function of the private BIDaaS blockchain. The first blockchain interface unit 130 generates a transaction including the virtual ID of the user, the public key of the user, and the generated electronic signature and adds the transaction to the private BIDaaS blockchain to register the virtual ID of the user. Here, the registration is generated as a blockchain transaction, broadcast to private BIDaaS blockchain nodes, and stored in the blockchain via an agreement algorithm.

The integrated ID and authentication management system based on a blockchain according to the aspect includes the registration request receiving unit 110, the encryption unit 120, and the first blockchain interface unit 130 and may further include a personal information DB 140.

The personal information DB 140 is a DB storing personal information of user accounts and stores personal information of users which is not stored in the private BIDaaS blockchain. Since the user already subscribes to the provider, the personal information is stored in the personal information DB 140 even before the virtual ID is registered.

Information stored in the personal information DB 140 includes information generally required by a partner to perform a service. The stored information may include the registered user's real name, phone number, and address. However, the stored information is not limited thereto, and various pieces of personal information may be stored depending on the service.

The integrated ID and authentication management system based on a blockchain according to the aspect includes the registration request receiving unit 110, the encryption unit 120, the first blockchain interface unit 130, and the personal information DB 140 and may further include a personal information processing unit 150.

According to an aspect of the present invention, a secured connection may be established between the provider server 100 and the partner server 200. For the secured connection, IPSec or TLS may be used. However, a security protocol for the secured connection is not limited thereto.

The personal information processing unit 150 may be implemented as a program code block executed by the microprocessor, that is, software. The personal information processing unit 150 may receive an extra personal information request corresponding to the virtual ID of the user from the partner server 200 through the secured connection, search the personal information DB 140 for the corresponding personal information, and transfer the personal information to the partner server 200.

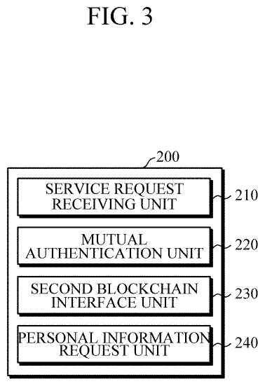

FIG. 3 is a block diagram of a partner server according to an embodiment of the present invention.

The partner server 200 of the integrated ID and authentication management system based on a blockchain according to the aspect includes a service request receiving unit 210, a second blockchain interface unit 230, and a mutual authentication unit 220.

The partner server 200 is a server managed by a company which provides a service to a user using the integrated ID and authentication service based on a blockchain. For example, the partner may be an online shopping mall.

The partner server 200 includes a microprocessor and a memory which stores a program code block executed by the microprocessor.

Also, the partner server 200 has a BIDaaS blockchain, which is copied from and synchronized with a private blockchain managed by a provider, and has a right to read from the owned private BIDaaS blockchain.

The service request receiving unit 210 may be implemented as a program code block executed by the microprocessor, that is, software. The service request receiving unit 210 receives a service request from the user terminal 300. Since a user who requests a service has not been registered with the partner, the user terminal 300 transmits a service request including a virtual ID, and the service request receiving unit 210 receives the service request.

The second blockchain interface unit 230 may be implemented as a program code block executed by the microprocessor, that is, software. When the service request is received, the second blockchain interface unit 230 verifies the received virtual ID by checking whether the virtual ID is stored in the private BIDaaS blockchain and acquires a public key of the user from the private BIDaaS blockchain.

The mutual authentication unit 220 may be implemented as a program code block executed by the microprocessor, that is, software. The mutual authentication unit 220 performs mutual authentication with the user terminal 300 using a nonce value included in the service request, the public key of the user, and a public key of the partner.

The partner server 200 of the integrated ID and authentication management system based on a blockchain according to the other aspect includes the service request receiving unit 210, the second blockchain interface unit 230, and the mutual authentication unit 220 and may further include a personal information request unit 240.

A secured connection may be established between the provider server 100 and the partner server 200. For the secured connection, IPSec or TLS may be used. However, a security protocol for the secured connection is not limited thereto.

The personal information request unit 240 may be implemented as a program code block executed by the microprocessor, that is, software. The personal information request unit 240 may request extra personal information including the user's real name, phone number, and address from the provider server 100 through the secured connection.

The requested personal information is information required by the partner to provide a specific service to the user. For example, when the partner is an online shopping mall, the requested personal information is a destination address of the user.

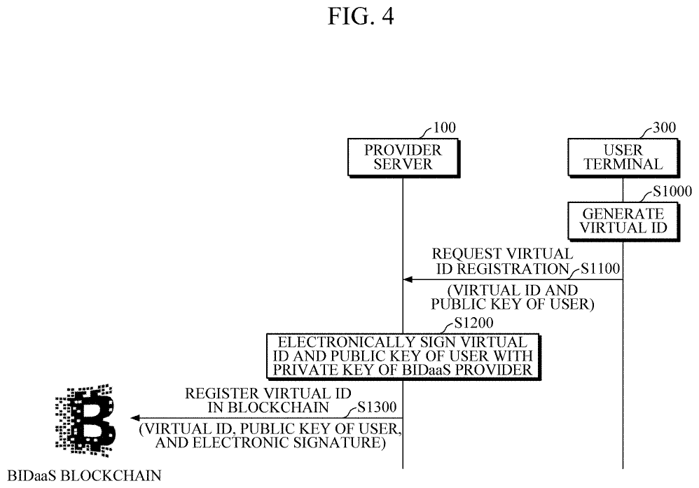

FIG. 4 is a sequence diagram illustrating a process of registering a virtual ID of a user according to an embodiment of the present invention. Referring to FIG. 4, the user terminal 300 generates a virtual ID using a public key of a user (S1000). The virtual ID may be generated by cryptographically hashing the public key of the user. A cryptographic hash algorithm may be MD5 or SHA 256. The user terminal 300 transmits a virtual ID registration request including the generated virtual ID of the user and the public key of the user to the provider server 100 (S1100). In this case, a connection between the provider server 100 and the user terminal 300 may be a secured connection.

The provider server 100 generates an electronic signature by signing the virtual ID of the user and the public key of the user received from the user terminal 300 with a private key of the provider server 100 (S1200). Subsequently, the provider server 100 registers the virtual ID by adding the virtual ID of the user, the public ID of the user, and the generated electronic signature to a private BIDaaS blockchain (S1300).

An integrated ID and authentication management service method based on a blockchain according to an aspect includes a step of receiving a virtual ID registration request and a step of registering a virtual ID.

A process of registering a virtual ID of a user is required for the provider server 100 to provide an integrated ID and authentication management service based on a blockchain. Since a user already subscribes to a service of the provider, preparation for using the service is finished by registering only the virtual ID.

In the step of receiving a virtual ID registration request, the provider server 100 receives a virtual ID registration request including a virtual ID of a user and a public key of the user from the user terminal 300.

In this case, the virtual ID of the user is generated by cryptographically hashing the public key of the user in the user terminal 300. A cryptographic hash algorithm may be MD5 or SHA 256.

In the step of registering the virtual ID, an electronic signature is generated by signing the virtual ID of the user and the public key of the user received by the provider server 100 with a private key of the provider server 100, and the virtual ID of the user is registered by generating and adding a transaction including the generated electronic signature, the virtual ID of the user, and the public ID of the user to a private BIDaaS blockchain.

In this way, the virtual ID of the user and the public key of the user may be successfully stored in the private BIDaaS blockchain, and the private BIDaaS blockchain may be used for the partner server 200, which requires the integrated ID and authentication management service, to verify the virtual ID of the user and acquire the public key of the user.

According to another aspect of the present invention, a secured connection may be established between the provider server 100 and the user terminal 300. For the secured connection, IPSec or TLS may be used. However, a security protocol for the secured connection is not limited thereto.

The provider server 100 may receive the virtual ID of the user and the public key of the user from the user terminal 300 through the secured connection.

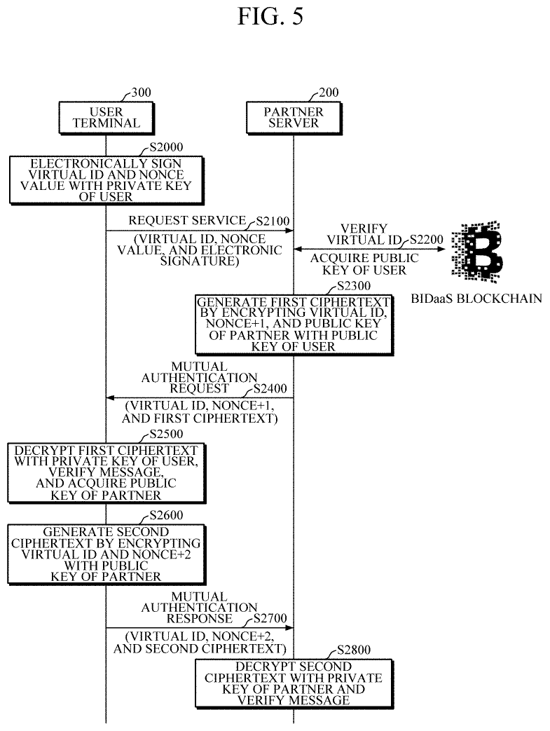

FIG. 5 is a sequence diagram illustrating a mutual authentication procedure between a user terminal and a partner server according to an embodiment of the present invention. Referring to FIG. 5, the user terminal 300 generates an arbitrary nonce value to prevent a replay attack and generates an electronic signature by signing the virtual ID of the user and the generated nonce value with a private key of the user (S2000). For example, the virtual ID of the user and the nonce value may be cryptographically hashed to generate a message digest, and the message digest may be encrypted with the private key of the user to generate an electronic signature. A cryptographic hash algorithm may be MD5 or SHA 256. Subsequently, the user terminal 300 transmits a service request including the virtual ID of the user, the nonce value, and the generated electronic signature to the partner server 200 (S2100).

The partner server 200 receives the service request from the user terminal 300, verifies the virtual ID included in the corresponding message through a private BIDaaS blockchain, and acquires the public key of the user from the private BIDaaS blockchain (S2200). The partner server 200 verifies the service request of the user by verifying the electronic signature included in the service request with the public key of the user. For example, the partner server 200 may generate a message digest by cryptographically hashing the virtual ID of the user and the nonce value included in the service request, decrypt the received electronic signature with the acquired public key of the user, and then verify the service request message of the user by comparing the message digest with the decrypted electronic signature. A cryptographic hash algorithm may be MD5 or SHA 256.

The partner server 200 generates first ciphertext by encrypting the virtual ID of the user, a value obtained by increasing the nonce value by 1, and a public key of the partner with the acquired public key of the user (S2300). Subsequently, the partner server 200 transmits a mutual authentication request including the virtual ID of the user, the value obtained by increasing the nonce value by 1, and the first ciphertext to the user terminal 300 (S2400).

The user terminal 300 acquires the public key of the partner by decrypting the first ciphertext included in the received mutual authentication request with the private key of the user. The user terminal 300 verifies the message by comparing the virtual ID of the user and the nonce value (the value obtained by increasing the nonce value included in the service request by the user terminal 300 by 1) acquired through the decryption with the virtual ID and the value obtained by increasing the nonce value by 1 which are included in the mutual authentication request (S2500).

Also, the user terminal 300 generates second ciphertext by encrypting the virtual ID and a value obtained by increasing the initially transmitted nonce value by 2 with the public key of the partner (S2600). Subsequently, the user terminal 300 transmits a mutual authentication response including the virtual ID of the user, the value obtained by increasing the initially transmitted nonce value by 2, and the second ciphertext to the partner server 200 (S2700).

The partner server 200 decrypts the second ciphertext in the received mutual authentication response with a private key of the partner and verifies the message by comparing the decrypted virtual ID of the user and the decrypted nonce value (the value obtained by increasing the nonce value included in the service request by the user terminal 300 by 2) with the virtual ID and the value obtained by increasing the initially transmitted nonce value by 2 which are included in the message (S2800). In this way, mutual authentication between the user and the partner server 200 is finished.

An integrated ID and authentication management service method based on a blockchain according to another aspect includes a step in which the partner server 200 receives a service request message, a step in which the partner server 200 acquires a public key of a user, a step in which the partner server 200 transmits an authentication request message, and a step in which the partner server 200 receives an authentication response message.

In the step of receiving a service request message, the partner server 200 receives a service request message including a virtual ID of a user from the user terminal 300. Here, the user is a subscriber who has been registered in a private BIDaaS blockchain but has not been registered in a partner service. The user terminal 300 requests a partner service by transmitting the virtual ID registered in the private BIDaaS blockchain to use the partner service without subscribing to the partner service and providing personal information.

The service request message includes a nonce value (hereinafter referred to as “r value”), which is temporarily generated to prevent the virtual ID from being illegally used, and an electronic signature of the virtual ID of the user and the r value made with a private key of the user. For example, the user terminal 300 may generate a message digest by cryptographically hashing the virtual ID of the user and the r value, generate an electronic signature by encrypting the message digest with the private key of the user, and include the electronic signature in the service request message. A cryptographic hash algorithm may be MD5 or SHA 256.

In the step of acquiring a public key of a user, the partner server 200 verifies the virtual ID included in the service request message received by the partner server 200 through the private BIDaaS blockchain and acquires a public key of the user. Verification of the virtual ID is a procedure for verifying whether the virtual ID has been registered in the private BIDaaS blockchain. The partner server 200 verifies the service request message with the acquired public key of the user.

In the step of transmitting an authentication request message, the partner server 200 transmits an authentication request message to the user terminal 300. The authentication request message is a message that the partner server 200 transmits to start mutual authentication in order to provide a service through mutual authentication with a user who has not been registered with the partner service.

The partner server 200 generates first ciphertext by encrypting the virtual ID of the user, a value of r+1, and a public key of the partner with the public key of the user, and the authentication request message transmitted by the partner server 200 includes the virtual ID of the user, the value of r+1, and the first ciphertext.

The user terminal 300 receiving the mutual authentication request message verifies the message by comparing the virtual ID and the value of r+1 included in the message with the virtual ID and the value of r+1 acquired by decrypting the first ciphertext with the private key of the user and acquires the public key of the partner through the decryption.

In the step of receiving an authentication response message, the partner server 200 receives an authentication response message from the user terminal 300. The authentication response message is a response message transmitted by the user terminal 300 in response to the authentication request message of the partner server 200 and finishes the mutual authentication procedure.

The user terminal 300 generates second ciphertext by encrypting the virtual ID of the user and a value of r+2 with the public key of the partner, and the authentication response message transmitted by the user terminal 300 includes the virtual ID of the user, the value of r+2, and the second ciphertext.

The partner server 200 receiving the mutual authentication response message verifies the message by comparing the virtual ID and the value of r+2 included in the message with the virtual ID and the value of r+2 acquired by decrypting the second ciphertext with a private key of the partner and finishes the mutual authentication procedure.

After the mutual authentication procedure is finished, the partner server 200 may provide a service desired by the user to the user. As such, the partner server 200 can provide a partner service wanted by the user through mutual authentication even when the user does not subscribe to the partner service or does not provide personal information.

The integrated ID and authentication management service method based on a blockchain according to the other aspect may further include a step in which the partner server 200 verifies the electronic signature with the public key of the user. In other words, the partner server 200 may verify the electronic signature included in the service request message received from the user terminal 300 with a public key of the user acquired from the private BIDaaS blockchain. For example, the partner server 200 may generate a message digest by cryptographically hashing the virtual ID and the r value included in the service request message and verify the electronic signature by comparing the message digest with a value obtained by decrypting the electronic signature with the public key of the user. A cryptographic hash algorithm may be MD5 or SHA 256.

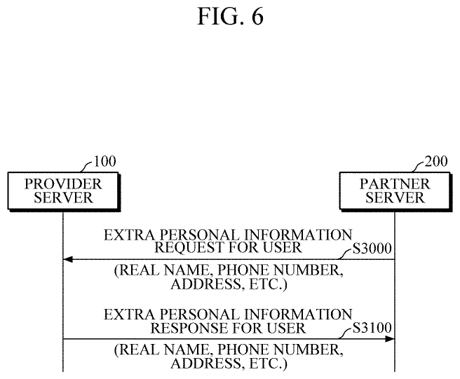

FIG. 6 is a sequence diagram illustrating an extra personal information acquisition process of a partner server according to another embodiment of the present invention. Referring to FIG. 6, the partner server 200 which finishes mutual authentication with the user terminal 300 may require extra personal information of the user to finish the service provided to the user and acquire the extra personal information from the provider server 100 rather than the private BIDaaS blockchain.

In the acquisition procedure, the partner server 200 transmits an extra personal information request message for the user to the provider server 100 (S3000). Here, the extra personal information may be the user's real name, phone number, address, and the like.

The provider server 100 receiving the extra personal information request message from the partner server 200 searches the personal information DB 140 for extra personal information, includes found extra personal information in an extra personal information response message, and transmits the extra personal information response message to the partner server 200 (S3100).

The partner server 200 may proceed with a service for the user on the basis of the received extra personal information.

According to another aspect of the present invention, a secured connection may be established between the provider server 100 and the partner server 200. For the secured connection, IPSec or TLS may be used. However, a security protocol for the secured connection is not limited thereto.

The partner server 200 may acquire the extra personal information corresponding to the virtual ID of the user from the provider server 100 through the secured connection.

While the embodiments of the present invention have been described with reference to the accompanying drawings, the present invention is not limited thereto, and the present invention should be construed as encompassing various modifications that can be devised from the embodiments by those of ordinary skill in the art. The claims are intended to cover all such modifications.

### INDUSTRIAL APPLICABILITY

The present invention can be industrially used in technical fields relating to identification and authentication based on the blockchain technology and application technology fields thereof.

1. An integrated identity (ID) and authentication management system based on a blockchain, the system comprising:
a provider server having a private blockchain-based ID as a service (BIDaaS) blockchain, capable of accessing the private BIDaaS blockchain using a right to write, and configured to generate a transaction including a virtual ID of a user, a public key of the user, and an electronic signature of the virtual ID and the public key made with a private key of the provider server and register the virtual ID of the user by adding the transaction to the private BIDaaS blockchain;
at least one partner server configured to provide a service to the user who is mutually authenticated and capable of accessing a private BIDaaS blockchain thereof using a right to read; and
a user terminal configured to register the virtual ID by transmitting the virtual ID and the public key to the provider server, request the service by transferring the virtual ID to the partner server, and use the service provided by a partner after mutual authentication with the partner server.

2. The ID and authentication management system based on a blockchain according to claim 1, wherein the provider server includes a personal information database (DB) configured to store extra personal information including real names, phone numbers, and addresses of registered users.

3. The ID and authentication management system based on a blockchain according to claim 1, wherein the provider server receives the virtual ID of the user and the public key of the user from the user terminal through a secured connection.

4. The ID and authentication management system based on a blockchain according to claim 1, wherein the partner server verifies the virtual ID received from the user terminal, which requests the service, through the private BIDaaS blockchain, acquires the public key of the user corresponding to the virtual ID, and performs the mutual authentication with the user terminal.

5. The ID and authentication management system based on a blockchain according to claim 2, wherein the partner server acquires extra personal information corresponding to the virtual ID of the user from the provider server through a secured connection.

6. The ID and authentication management system based on a blockchain according to claim 1, wherein the user terminal generates the virtual ID by cryptographically hashing the public key of the user.

7. A provider server having a right to write in a private blockchain-based identity as a service (BIDaaS) blockchain thereof and comprising:
a registration request receiving unit configured to receive a virtual ID registration request including a virtual ID of a user and a public key of the user from a user terminal;
an encryption unit configured to generate an electronic signature by signing the virtual ID of the user and the public key of the user with a private key thereof; and
a first blockchain interface unit configured to generate a transaction including the virtual ID of the user, the public key of the user, and the generated electronic signature and register the virtual ID of the user by adding the transaction to the private BIDaaS blockchain.

8. The provider server according to claim 7, further comprising a personal information database (DB) configured to store extra personal information including real names, phone numbers, and addresses of registered users.

9. The provider server according to claim 7, wherein the registration request receiving unit receives the virtual ID of the user and the public key of the user from the user terminal through a secured connection.

10. The provider server according to claim 8, further comprising a personal information processing unit configured to receive a request message for extra personal information corresponding to the virtual ID of the user from a partner server through a secured connection and transfer extra personal information found in the personal information DB.

11. A partner server having a right to read from a private blockchain-based identity as a service (BIDaaS) blockchain thereof and comprising:
a service request receiving unit configured to receive a service request including a virtual ID of a user from a user terminal;
a second blockchain interface unit configured to verify the virtual ID of the user through the private BIDaaS blockchain and acquire a public key of the user from the private BIDaaS blockchain; and
a mutual authentication unit configured to perform mutual authentication with the user terminal.

12. The partner server according to claim 11, further comprising a personal information request unit configured to request extra personal information including a real name, a phone number, and an address of the user from a provider server through a secured connection.

13-21. (canceled)
